(19) United States
(12) Patent Application Publication
(10) Pub. No.: US 2005/0246902 A1
(43) Pub. Date: Nov. 10, 2005

(54) Rotary extendable hair clipper

(75) Inventor: Yehuda Poran, Golan Heights (IL)

Correspondence Address: STEIN, MCEWEN & BUI, LLP, 1400 EYE STREET, NW, SUITE 300, WASHINGTON, DC, 20005, US

(73) Assignee: EPILADY 2000, L.L.C., Hatzor Haglilit (IL)

(21) Appl. No.: 11/177,589

(22) Filed: Jul. 11, 2005

(30) Foreign Application Priority Data
Mar. 18, 2004 (IL) 160955

(51) Int. Cl. B26B 19/00

(52) U.S. Cl. 30/201; 30/199

(57) ABSTRACT

A hair cutting apparatus, including a chassis to support a motor to drive a cutting blade, the apparatus comprising a rotary ring, including an inner circumferential surface, rotatably mounted on said chassis, a threaded screw, constrained within said chassis against non-rotational movement, having a head including an outer circumferential surface to engage with the inner circumferential surface of the rotary ring and a shaft including threads, the threaded screw rotating in response to the rotation of the rotary ring, a longitudinal positioner, having a socket including threads to engage with said threads of the threaded screw, to move in a longitudinal direction relative to the cutting blade in accordance with the rotation of the threaded screw, and a hair engagement comb coupled with said longitudinal positioner to position hair to be cut by the cutting blade.

### CROSS REFERENCE TO RELATED APPLICATION

This application is based on related Israeli Application No. 160955, filed Mar. 18, 2004, in the Israeli Intellectual Property Office, the disclosure of which is incorporated herein by reference.

### BACKGROUND OF THE INVENTION

1. Field of the Invention

The present invention relates to hair clippers generally, and, more particularly, to a hair cutting apparatus, including an extendable hair engagement comb.

2. Description of the Related Art

Conventional hair clippers with varying cut length capability have been well known for some time. Generally, these included devices in which a movable blade is moved relative to a stationary blade for varying a cut length of hairs by moving an adjuster handle mounted on a housing of the hair clipper in a direction along the longitudinal axis of the housing. The movable blade is interlocked with the adjuster handle through a linkage member in such a manner that the movable blade is moved in a rearward direction along the longitudinal axis to reduce the cut length when the adjuster handle is moved in a forward direction along the longitudinal axis.

However, since the movable blade in conventional devices is urged against the stationary blade by a torsion spring to provide a suitable spring bias to cause a hair shearing reciprocating motion of the movable blade on the stationary blade, a relatively large manipulation force is required to slide the adjuster handle and therefore the movable blade against a friction between the blades when adjusting the cut length of the hairs.

In addition, the adjuster handle of the conventional devices includes a latch means capable of stably holding a shearing position of the movable blade relative to the stationary blade during the shearing operation. The latch means includes a release knob projecting on a portion of the adjuster handle to be accessible by a finger of an operator manipulating the handle. The release knob is provided to unlatch the adjustor handle upon being pressed to thereby permit a sliding movement of the handle for varying the cut length. Eventually, the operator is required to press the release knob for sliding the adjuster handle besides the above described manipulation force. This is inconvenient and is therefore a cause of accumulating fatigue of a wrist or fingers of the operator when shearing the hairs while varying the cut length continuously and manually. Additionally, it may be expected that such linkage member and latch means create difficulties because of necessary complex structures.

These problems have been addressed in hair clippers that have a cutter head on the front end of a housing which includes a toothed stationary blade and a toothed movable blade reciprocating on the stationary blade in a hair shearing engagement between individual toothed edges thereof. The movable blade is slidable relative to the stationary blade in an edgewise direction perpendicular to the reciprocating motion of the movable blade for varying a cut length of hairs. An adjuster handle is slidably fitted on an outer round surface of the housing and linked to the movable blade through a linkage member such that the movable blade is shifted in the edgewise direction to increase and reduce the cut length by rotating the adjuster handle about a longitudinal axis of the housing.

However, since the cutting blade is moved relative to the stationary blade, the ability to cut hair at any particular length is limited to the distance between the stationary blade from the housing, which is predetermined at the time of manufacture and which is necessarily relatively short relative to desired hair lengths for many people.

Further, since the hair-cutting blade is moved relative to the body of the device, the blade may be damaged during the course of the lifetime of the blade, resulting in lowered reliability and cutting efficiency.

### SUMMARY OF THE INVENTION

An aspect of the present invention provides a hair cutting apparatus, comprising a chassis to support a motor to drive a cutting blade, a rotary ring, including an inner circumferential surface, rotatably mounted on said chassis,a threaded screw having a head including an outer circumferential surface to engage with the inner circumferential surface of the rotary ring, and a shaft including threads, the threaded screw rotating in response to the rotation of the rotary ring, a longitudinal positioner having threads to engage with said threads of the threaded screw, to move in a longitudinal direction relative to the chassis in accordance with the rotation of the threaded screw and a hair engagement comb coupled with said longitudinal positioner to position hair to be cut by the cutting blade.

Another aspect of the invention provides a hair cutting apparatus, including a chassis to support a motor to drive a cutting blade, the apparatus comprising a rotary ring, including an inner circumferential surface, rotatably mounted on said chassis, a threaded screw, constrained within said chassis against non-rotational movement, having a head including an outer circumferential surface to engage with the inner circumferential surface of the rotary ring and a shaft including threads, the threaded screw rotating in response to the rotation of the rotary ring, a longitudinal positioner, having a socket including threads to engage with said threads of the threaded screw, to move in a longitudinal direction relative to the chassis in accordance with the rotation of the threaded screw, and a hair engagement comb coupled with said longitudinal positioner to position hair to be cut by the cutting blade.

Another aspect of the invention provides a hair cutting apparatus, including a chassis to support a motor to drive a cutting blade, the apparatus comprising a rotary ring, including an inner circumferential surface, rotatably mounted on said chassis, a threaded screw, constrained within said chassis against non-rotational movement, having a head including an outer circumferential surface to engage with the inner circumferential surface of the rotary ring and a shaft including threads, the threaded screw rotating in response to the rotation of the rotary ring, and a longitudinal positioner, having a socket including threads to engage with said threads of the threaded screw, to position a hair engagement comb at a desired distance from the cutting blade in accordance with the rotation of the threaded screw.

Another aspect of the invention provides a hand held hair cutting apparatus, including a cutting assembly, comprising a first member, disposed on a surface of the apparatus, to be selectively moved by a user in forward and reverse directions, a second member, disposed within the apparatus, to transform the movement of the first member into linear movement relative to the cutting assembly, and a third member, extending from the second member to an exterior of the apparatus, to position a hair engagement device a distance from the cutting assembly in accordance with the selection of the user.

Still yet another aspect of the invention provides a method of operating a hand held hair cutting apparatus, including a cutting assembly, comprising selectively moving a first member, disposed on a surface of the apparatus, in forward and reverse directions, transforming the movement of the first member into linear movement based on an amount of the selective movement of the first member relative to the cutting assembly, and positioning a hair engagement device a distance from the cutting assembly in accordance with the linear movement.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are illustrations of an extendable hair-clipping device constructed and operative in accordance with an embodiment of the present invention in a retracted orientation and an extended orientation, respectively;

FIG. 2 is an exploded view illustration of the hair-clipping device of FIGS. 1A and 1B;

FIG. 3 is an illustration of a comb driving assembly in operative association with a hair length control ring and a hair engagement comb which form part of the hair-clipping device of FIGS. 1A-2;

FIGS. 4A and 4B are respectively, a pictorial illustration and a sectional illustration of a hair length control ring, the sectional illustration being taken along section lines IVB-IVB in FIG. 4A;

FIGS. 5A and 5B are respectively a pictorial illustration and a side view planar illustration of the operative engagement between teeth on a screw head and teeth on an array on the hair length control ring of FIGS. 4A and 4B;

FIGS. 6A, 6B and 6C are respectively, a pictorial illustration, a top view planar illustration and a sectional illustration of a slidable longitudinal positioner, which forms part of the hair-clipping device of FIGS. 1A-2, the sectional illustration being taken along section lines VIC-VIC in FIG. 6B;

FIGS. 7A and 7B are respectively top and bottom pictorial illustrations of a hair engagement comb which forms part of the hair clipper device of FIGS. 1A-2;

FIGS. 8A and 8B are pictorial illustrations of the hair length control ring in operative association with the comb driving assembly and the hair engagement comb mounted onto the main chassis of FIG. 2, showing hair engagement comb in retracted and extended orientations, respectively;

FIG. 9 illustrates a hand-held hair cutting apparatus in accordance with an embodiment of the invention; and

FIG. 10 is a flow chart to describe a method of operating a hand-held hair cutting apparatus in accordance with an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

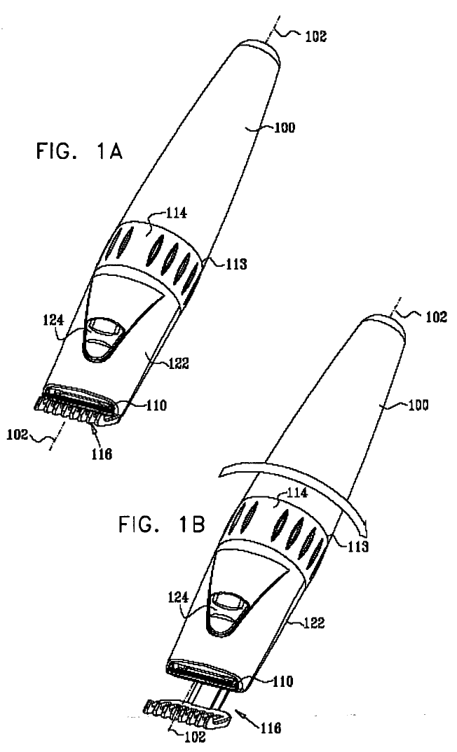

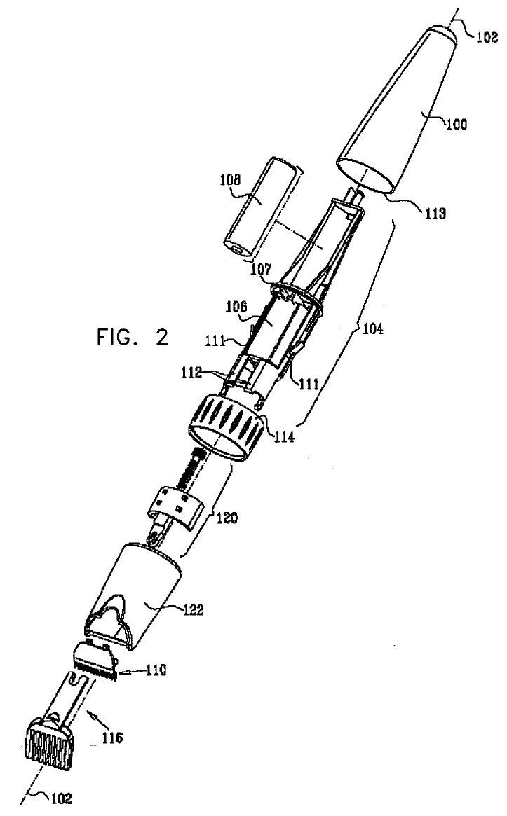

Reference is now made to FIGS. 1A and 1B, which are pictorial illustrations of an extendable hair-clipping device constructed and operative in accordance with an embodiment of the present invention in a retracted orientation and an extended orientation respectively and to FIG. 2 which is an exploded view illustration of the hair-clipping device of FIGS. 1A and 1B.

As seen in FIGS. 1A, 1B and 2, the hair-clipping device comprises a generally conical rear housing portion 100 that is arranged about a longitudinal axis 102. The rear housing portion 100 partially encloses a main chassis 104. The main chassis 104 supports a motor 106, a screw head socket 107 and a battery 108 to power the motor. The motor 106 drives a cutting blade assembly 110 in a reciprocating cutting motion. The construction and operation of the motor 106 is well known in the art. Elongated axial edges 111 and elongated side supports 112 are also formed on the main chassis 104.

A rotatable hair length control ring 114 is rotatably mounted onto a forward edge 113 of rear housing portion 100. The rotatable hair length control ring 114 selectively positions a hair engagement comb 116 along an axis 102 in variable positions along a longitudinal direction. A rotatable motion of hair length control ring 114 about the axis 102 is converted to longitudinal motion of the hair engagement comb 116 about the axis 102 by a comb driving assembly 120, which is located within a forward housing portion 122.

A cutting blade assembly 110 is located at a forward end of forward housing portion 122 and the hair engagement comb 116 is located forwardly of the cutting blade assembly 110 along the longitudinal axis 102 by a selectable distance related to an amount of the rotation of the hair length control ring 114, as seen in FIGS. 1A and 1B, which is to be determined by a user. An electric motor on-off switch 124 is also mounted onto forward housing portion 122 and which will be described below.

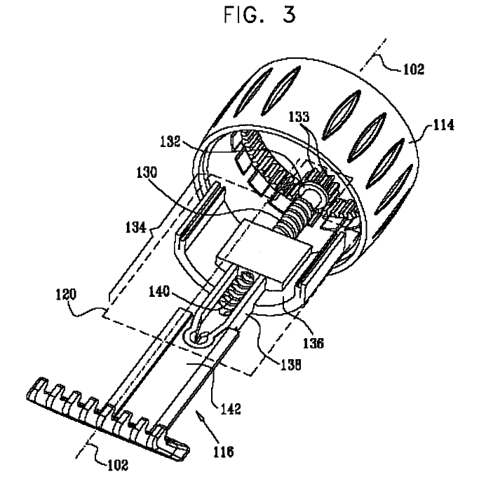

With reference to FIG. 3, which is a simplified pictorial illustration of the comb driving assembly 120 in operative association with the hair length control ring 114 and the hair engagement comb 116, the comb driving assembly 120 comprises a threaded screw 130 having a head 132, which is formed with gear teeth 133. The threaded screw 130 is disposed to be driven in a rotational direction as a result of an engagement between the threaded screw 130 and the hair length control ring 114.

The threaded screw 130 engages a slidable longitudinal positioner 134 including a support portion 136 and an elongated portion 138 which is formed with a threaded socket 140. A threading pattern of the threaded socket 140 generally corresponds with that of the threaded screw. A forward end of elongated portion 138 may engage with an extension portion 142 of the hair engagement comb 116 in a snap fit engagement.

Thus, a manual rotation of the hair length control ring 114 produces a corresponding rotation of the threaded screw 130. This, in turn, produces a longitudinal displacement of the longitudinal positioner 134 along the axis 102.

It is understood that the tooth-to-tooth engagement between the threaded screw 130 and the array 150 of teeth 152 of the hair length control ring 114 is only one embodiment of the invention. An alternate embodiment, in which the outer surface of the threaded screw 130 and the inner surface of the hair length control ring 114 comprise frictional surfaces that contact with each other, is possible. According to this embodiment, a rotation of the hair length control ring 114 causes a corresponding rotation of the threaded screw 130 due to the frictional contact between the outer and inner surfaces of the hair length control ring 114 and the threaded screw 130. Of course, yet additional embodiments, which provide for similar effects, are also possible.

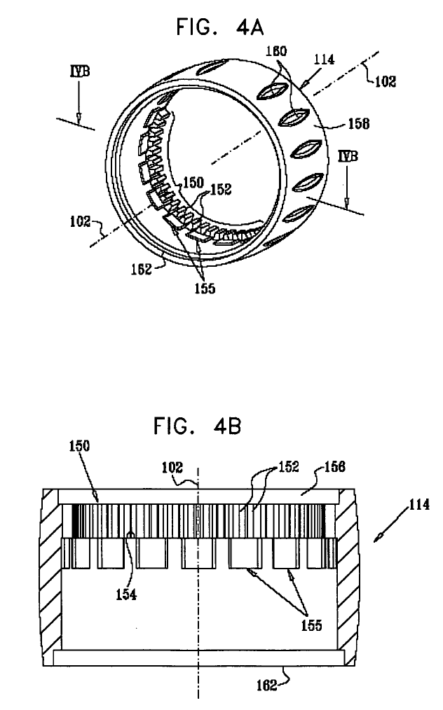

Reference is now made to FIGS. 4A and 4B which illustrate the hair length control ring 114. As seen in FIGS. 4A and 4B the hair length control ring 114 is generally cylindrical ring-shaped and includes an array 150 of teeth 152 arranged along an inner circumferential surface 154 thereof, which is located along a rearward-facing flange 156. Rearward-facing flange 156 is configured for rotational sliding engagement with forward edge 113 of rear housing portion 100. According to an embodiment of the invention, the array 150 extends along most, but not all, of the extent of circumferential surface 154 so as to define an extent of the rotation of the threaded screw 130 and, thus, of the longitudinal travel of the hair engagement comb. A row of square protrusions 155 may be located forwardly of the array 150, according to an embodiment of the invention, and extends along the extent of the circumferential surface 154. The row 155 is configured to provide resistance to rotation of hair length control ring 114.

An outer surface 158 of the hair length control ring 114 may be formed with dimples 160 to enhance a frictional engagement therewith by the fingers of the user. A forward facing flange 162 may be provided for rotational sliding engagement between the hair length control ring 114 and a corresponding rearward facing edge of the forward housing 122.

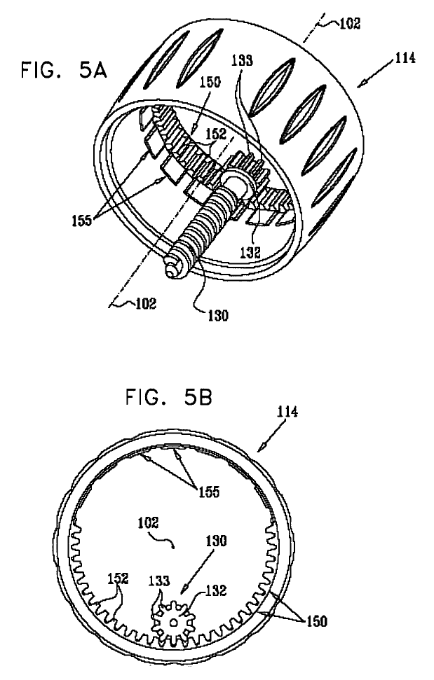

Reference is now made to FIGS. 5A and 5B, which illustrate the operative engagement between the teeth 133 of the screw head 132 and the teeth 152 of the array 150 on ring 114. As is illustrated, the threaded screw 130 is constrained against longitudinal movement along the axis 102 by the encasement of the screw head 132 in the screw head socket 107 of the main chassis 104. Thus, the rotation thereof in the threaded socket 140 produces a corresponding longitudinal displacement of the positioner 134.

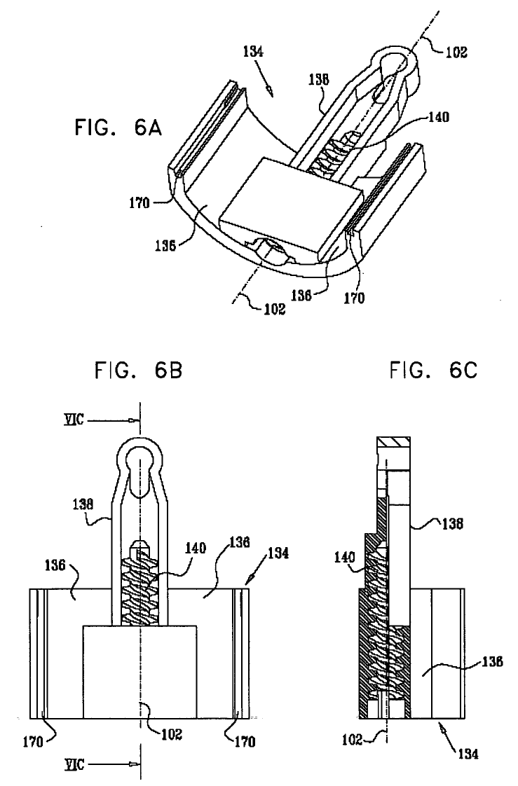

Reference is now made to FIGS. 6A-6C, which illustrate the slidable longitudinal positioner 134. As is noted above, the positioner 134 includes the support portion 136 and elongated portion 138, which is formed with the threaded socket 140, whose threading generally matches that of the threaded screw 130. The support portion 136 includes slotted edges 170 which are configured for longitudinal sliding engagement with corresponding elongated edges 111 of the main chassis 104.

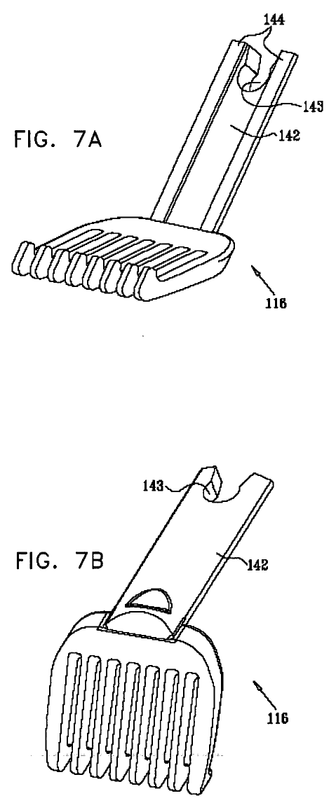

Reference is now made to FIGS. 7A and 7B, which illustrate the hair engagement comb 116. As is described hereinabove with reference to FIG. 3, the extension portion 142 of the hair engagement comb 116, is configured with a snap fit socket 143 to provide for the engagement between the hair engagement comb 116 with a forward end of the elongated portion 138 of the slidable longitudinal positioner 134. The extension portion 142 has elongated edge protrusions 144, configured for longitudinal sliding engagement within the elongated side supports 112 that are formed on the main chassis 104.

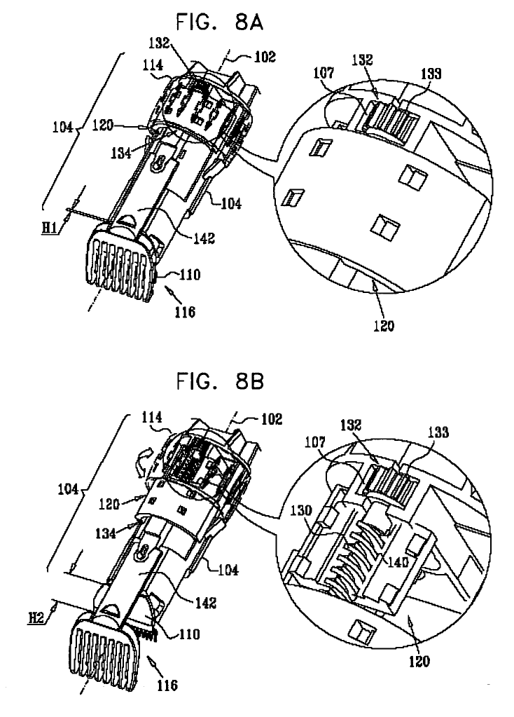

Reference is now made to FIGS. 8A and 8B which show the hair length control ring 114 in operative association with the comb driving assembly 120, the hair engagement comb 116 and the main chassis 104. As seen in FIGS. 8A and 8B, respective retracted and elongated positions of the hair engagement comb 116 correspond to respective first and second rotational orientations of hair length control ring 114. A rotation of the hair length control ring 114 is converted to an axial displacement of hair engagement comb 116 by the engagement of array 150 of the teeth 152 with the head 132 of the threaded screw 130, producing rotation thereof. Since the threaded screw 130 is constrained against a longitudinal movement along the axis 102 by the screw head socket 107, a rotation thereof in the threaded socket 140 produces a corresponding longitudinal displacement of the positioner 134 and, thus, a displacement of the hair engagement comb 116.

Various mechanisms in addition to the row of protrusions 155 to hold the hair engagement comb 116 in place relative to the forward housing 122 will now be described with reference to methods of operation of the hair clipping device of the present invention. First, once a user has positioned the hair engagement comb 116 in a desired position and thereafter begins cutting a hair cutting operation, it is understood that a compressing force applied to the hair engagement comb 116 to tend to cause the hair engagement comb 116 to move toward the forward housing 122 will be applied by the surface of a body undergoing the hair cutting operation. According to an embodiment of the invention, however, an angle and friction generated between the corresponding threads of the threaded screw 130 and the threaded socket 140 as well as the friction generated between the teeth 152 of the array 150 and the teeth 133 of the screw head 132 combine to prevent a compression of the hair engagement comb 116 toward the forward housing 122 under a compressing force applied by the body.

According to other embodiments of the invention, a compression of the hair engagement comb 116 toward the forward housing 122 may be prevented by a latch system and/or a locking system which selectively disengages the threaded screw 130 from either the threaded socket 140 or the array 150 of teeth 152 and/or prevents a rotation of either the threaded screw 130 and the array 150 of teeth 152 or a longitudinal movement of the threaded socket 140.

It is understood that such a latch system and/or a locking system may provide either predetermined cutting positions at which the hair clipping device may be set, or may allow a user to set a hair cutting length at any length given the length of the extension portion 142 of the hair engagement comb 116.

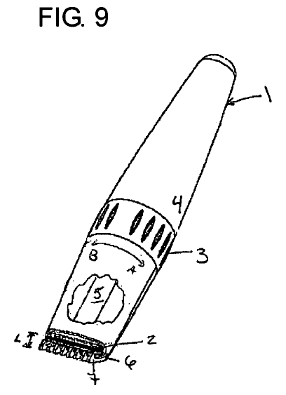

With respect to FIG. 9, an aspect of the invention is illustrated. According to this embodiment, a hand held hair cutting apparatus 1, including a cutting assembly 2, comprises a first member 3, disposed on a surface 4 of the apparatus 1, to be selectively moved by a user in forward and reverse directions (designated by arrows A and B), a second member 5, disposed within the apparatus 1, to transform the movement of the first member 3 into linear movement relative to the cutting assembly 2, and a third member 6, extending from the second member 5 to an exterior of the apparatus 1, to position a hair engagement device 7 a distance L from the cutting assembly 2 in accordance with the selection of the user. It is understood that the operation of the second member 5, in particular, may be understood in light of the above-described embodiments, and, additionally, in view of the fact that these embodiments are not limiting and that there are additional arrangements and structures that are available.

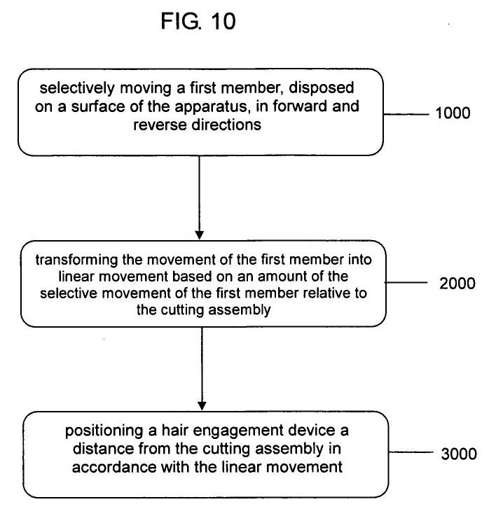

With respect to FIG. 10, a method of operating a hand held hair cutting apparatus, including a cutting assembly, comprises (operation 1000), transforming the movement of the first member into linear movement based on an amount of the selective movement of the first member relative to the cutting assembly (operation 2000); and positioning a hair engagement device a distance from the cutting assembly in accordance with the linear movement (operation 3000).

Although a few embodiments of the present invention have been shown and described, it would be appreciated by those skilled in the art that changes may be made in these embodiments without departing from the principles and spirit of the invention, the scope of which is defined in the claims and their equivalents.

1. A hair cutting apparatus, comprising:
a chassis to support a motor to drive a cutting blade;
a rotary ring, including an inner circumferential surface, rotatably mounted on said chassis;
a threaded screw having a head including an outer circumferential surface to engage with the inner circumferential surface of the rotary ring, and a shaft including threads, the threaded screw rotating in response to the rotation of the rotary ring;
a longitudinal positioner having threads to engage with said threads of the threaded screw, to move in a longitudinal direction relative to the cutting blade in accordance with the rotation of the threaded screw; and
a hair engagement comb coupled with said longitudinal positioner to position hair to be cut by the cutting blade.

2. The apparatus according to claim 1, wherein said a cutting blade comprises a cutting blade assembly.

3. The apparatus according to claim 1, further comprising a screw head socket on said chassis to constrain said threaded screw against non-rotational movement.

4. The apparatus according to claim 1, wherein said toothed rotary ring comprises an array of teeth arranged along the inner circumferential surface thereof and wherein said head of said threaded screw comprises an array of teeth along the outer circumferential surface thereof, said teeth of the rotary ring being cooperable with said teeth of the threaded screw.

5. The apparatus according to claim 1, wherein said rotary ring selectively positions said hair engagement comb with respect to said cutting blade assembly.

6. The apparatus according to claim 1, wherein said hair engagement comb comprises an extension portion to define a distance between the hair engagement comb and the longitudinal positioner.

7. The apparatus according to claim 6, wherein said longitudinal positioner comprises:
a support portion to slidingly engage said chassis;
an elongated portion including a forward end to be snap fit with said extension portion of said hair engagement comb, and wherein said elongated portion also comprises a threaded socket to threadably engage with said screw.

8. The apparatus according to claim 7, wherein said elongated portion comprises elongated edge protrusions to slidingly engage with said chassis.

9. A hair cutting apparatus, including a chassis to support a motor to drive a cutting blade, the apparatus comprising:
a rotary ring, including an inner circumferential surface, rotatably mounted on said chassis;
a threaded screw, constrained within said chassis against non-rotational movement, having a head including an outer circumferential surface to engage with the inner circumferential surface of the rotary ring and a shaft including threads, the threaded screw rotating in response to the rotation of the rotary ring;
a longitudinal positioner, having a socket including threads to engage with said threads of the threaded screw, to move in a longitudinal direction relative to the cutting blade in accordance with the rotation of the threaded screw; and
a hair engagement comb coupled with said longitudinal positioner to position hair to be cut by the cutting blade.

10. The apparatus according to claim 10, further comprising a conical rear housing portion partially enclosing the chassis.

11. The apparatus according to claim 10, further comprising elongated axial edges and elongated side supports formed on the chassis.

12. The apparatus according to claim 10, wherein the head of the threaded screw comprises teeth arrayed on the outer circumference thereof and the rotary ring comprises teeth arrayed on the inner circumference thereof, the teeth of the rotary ring and the teeth the threaded screw being cooperable with each other.

13. The apparatus according to claim 11, wherein the rotary ring comprises a rearward facing flange to be slidably engaged with a forward edge of the rear housing portion.

14. The apparatus according to claim 14, wherein the rotary ring further comprises a row of protrusions to provide resistance to a rotation of the rotary ring.

15. The apparatus according to claim 14, wherein the rotary ring further comprises dimples on an outer surface thereof to enhance a frictional engagement therewith by fingers of a user.

16. The apparatus according to claim 10, further comprising a screw head socket of the chassis to encase the screw so as to constrain the screw against longitudinal movement relative to the chassis.

17. The apparatus according to claim 10, wherein the longitudinal positioner comprises slotted edges to longitudinally and slidably engage with the elongated axial edges and elongated side supports of the chassis.

18. The apparatus according to claim 10, wherein the hair engagement comb comprises an extension portion having a snap fit socket to provide for an engagement between the hair engagement comb and the longitudinal positioner.

19. The apparatus according to claim 10, wherein the cooperation between the rotary ring, the threaded screw, and the longitudinal positioner prevent a compression of the hair engagement comb toward the cutting blade during a normal operation of the apparatus.

20. A hair cutting apparatus, including a chassis to support a motor to drive a cutting blade, the apparatus comprising:
a rotary ring, including an inner circumferential surface, rotatably mounted on said chassis;
a threaded screw, constrained within said chassis against non-rotational movement, having a head including an outer circumferential surface to engage with the inner circumferential surface of the rotary ring and a shaft including threads, the threaded screw rotating in response to the rotation of the rotary ring; and
a longitudinal positioner, having a socket including threads to engage with said threads of the threaded screw, to position a hair engagement comb at a desired distance from the cutting blade in accordance with the rotation of the threaded screw.

21. A hair cutting apparatus, including a chassis supporting a motor to drive a cutting blade to cut hair held in position by a hair engagement comb, the apparatus comprising:
a rotary ring, including an inner circumferential surface, rotatably mounted on said chassis to be selectively rotated by a user;
a screw, constrained within said chassis against non-rotational movement, having a head including an outer circumferential surface to engage with the inner circumferential surface of the rotary ring and a shaft including threads, the screw rotating in response to the rotation of the rotary ring; and
a longitudinal positioner, having a socket including threads to engage with said threads of the threaded screw, to position the hair engagement comb in a longitudinal direction relative to the cutting blade in accordance with the rotation of the threaded screw.

22. A hand held hair cutting apparatus, including a cutting assembly, comprising:
a first member, disposed on a surface of the apparatus, to be selectively moved by a user in forward and reverse directions;
a second member, disposed within the apparatus, to transform a force generated by the movement of the first member into a force acting in a linear direction relative to the cutting assembly; and
a third member, extending from the second member to an exterior of the apparatus, to position a hair engagement device a distance from the cutting assembly in response to the force acting in the linear direction.

23. The apparatus according to claim 22, wherein the forward and reverse directions are rotational directions.

24. A method of operating a hand held hair cutting apparatus, including a cutting assembly, comprising:
selectively moving a first member, disposed on a surface of the apparatus, in forward and reverse directions;
transforming the movement of the first member into linear movement based on an amount of the selective movement of the first member relative to the cutting assembly; and
positioning a hair engagement device a distance from the cutting assembly in accordance with the linear movement.
